(19) United States
(12) Patent Application Publication
(10) Pub. No.: US 2020/0090138 A1
(43) Pub. Date: Mar. 19, 2020

(54) Method, System, and Computer Program Product for Flexible Settlement Decisions

(71) Applicant: Visa International Service Association, San Francisco, CA (US)

(72) Inventors: Karen L. Cervenka, Belmont, CA (US); Brendan Xavier Louis, Manteca, CA (US); David Tseselsky, San Jose, CA (US); Sushma Bhoja Shetty, Reston, VA (US)

(21) Appl. No.: 16/494,436

(22) PCT Filed: Mar. 21, 2018
(86) PCT No.: PCT/US2018/023527

§ 371 Date: Sep. 16, 2019

Related U.S. Application Data
(60) Provisional application No. 62/475,046, filed on Mar. 22, 2017.

(51) Int. Cl. G06Q 20/02; G06Q 20/34; G06Q 20/40

(52) U.S. Cl. CPC G06Q 20/023; G06Q 20/4016; G06Q 20/405; G06Q 20/34

(57) ABSTRACT

Provided is a computer-implemented method for dynamically designating a settlement window for a transaction within a settlement cycle between an acquirer and an issuer. The method includes receiving a plurality of transaction records associated with a plurality of transactions, determining a first settlement window of a plurality of settlement windows to assign a transaction record of the plurality of transaction records, assigning the transaction record of the plurality of transaction records to the first settlement window based on determining the first settlement window of the plurality of settlement windows to assign the transaction record, and performing a settlement function for a transaction associated with the transaction record assigned to the first settlement window based on assigning the transaction record of the plurality of transaction records to the first settlement window. A system and computer program product are also disclosed.

### CROSS REFERENCE TO RELATED APPLICATION

This application claims priority to U.S. Provisional Application No. 62/475,046 filed Mar. 22, 2017, the disclosure of which is incorporated in its entirety by reference.

### BACKGROUND OF THE INVENTION

### Field of the Invention

This invention relates generally to funds settlement between financial institutions as it relates to card processing, and in one particular embodiment, a system for segmentation of clearing settlements into a plurality of settlement positions and windows.

### Technical Considerations

Funds transfers between banks are an integral part of the modern economy. In a typical transaction, funds are moved between an issuing bank and an acquiring bank. For funds to be transferred, transaction records are sent through an intermediary clearing and settlement process before being moved. The clearing and settlement step is a batch process in which a large number of card transactions are processed, aggregated, and net positions are determined before the funds are moved between participants.

Clearing and settlement systems and methods may employ a single criteria for clearing, settlement, and movement of funds. In some instances, a single predetermined settlement time is used to settle all domestic transactions, usually on a daily basis (e.g., all transactions are settled at one time during a day), between all issuers and acquirers in a given country. Thus, criteria for settlement may be jurisdictional, with each country settling all domestic transactions in a single time period. Existing systems have several inherent disadvantages. In general, current settlement systems do not provide for any flexibility based on the individual needs of participants. Additionally, current settlement systems tie up funds until the predetermined settlement time. This can be a substantial burden for some participants, for example, acquirers who pre-fund merchants. In such an example, the acquirer may not receive the funds based on a transaction until the predetermined settlement time after authorization of the transaction. In some instances, the settlement of the transaction may not occur until a predetermined time period (e.g., 1-3 days) after the transaction is conducted.

Further, existing settlement systems handle all clearing and settlement of all transactions at a single predetermined settlement time, which substantially complicates the movement of funds when potentially high-risk activity is detected.

Accordingly, there is a need in the technological arts for providing systems and methods for allowing participants to have flexibility in how and when their transactions are settled. Additionally, there exists a need in the technological arts for providing systems and methods for more efficient clearing and settlement when high-risk transactions are detected.

### SUMMARY OF THE INVENTION

According to a non-limiting embodiment or aspect, provided is a computer-implemented method for dynamically designating a preferred settlement window for a transaction within a settlement cycle between an acquirer and an issuer, the method including: receiving communications comprising transaction records at a settlement decisioning engine from an acquirer, the settlement decisioning engine having a processor and memory that stores a transaction record comprising information about a merchant transaction, including account numbers and transaction amounts; for each received transaction record, generating and associating business criteria with each received transaction based at least partially on the merchant transaction information, acquirer processing information, and settlement preferences (e.g., the settlement preferences of the issuers and/or acquirers); matching criteria of a settlement window from a plurality of settlement windows with business criteria associated with a transaction record; and transmitting the matched transaction records to the participating issuers based upon their processing and settlement preferences as part of a settlement.

In one non-limiting embodiment or aspect, the communications include a clearing message or an authorization message.

In one non-limiting embodiment or aspect, the settlement includes multiple settlement transactions.

In one non-limiting embodiment or aspect, the criteria of the settlement window includes jurisdictions, each jurisdiction associated with a flexible set of settlement rules.

In one non-limiting embodiment or aspect, generating business criteria further includes matching each record with a type of transaction from the set comprising on-us, credit, debit, and merchant identification value.

In one non-limiting embodiment or aspect, the settlement decisioning engine routes the clearing message to the card issuer and calculates the settlement obligation of the issuer and the amount due to the acquirer a net of certain applicable fees and charges.

In one non-limiting embodiment or aspect, anomalies, including transaction volumes or dollar values in a settlement window, cause withholding of settlement, and removing high-risk records before sending.

In one non-limiting embodiment or aspect, provided is a non-transitory computer readable medium with computer executable instructions stored thereon executed by a processor to perform the method of dynamically designating a preferred settlement window for a transaction within a settlement cycle between an acquirer and an issuer, the method including: receiving communications comprising transaction records at a settlement decisioning engine from an acquirer, the settlement decisioning engine having a processor and memory that stores a transaction record comprising information about a merchant transaction, including account numbers and transaction amounts; for each received transaction record, generating and associating business criteria with each received transaction based at least partially on the merchant transaction information, acquirer processing information, and settlement preferences (e.g., the settlement preferences of the issuers and/or acquirers); matching criteria of a settlement window from a plurality of settlement windows with business criteria associated with a transaction record; and transmitting matched transaction records to the participating issuers based upon their processing and settlement preferences as part of a settlement.

In one non-limiting embodiment or aspect, provided is a payment network system for dynamically designating a preferred settlement window for a transaction within a settlement cycle between an acquirer and an issuer, the system including: a settlement decisioning engine, the settlement decisioning engine comprising a processor and memory for storing a transaction, the transaction comprising information about a merchant transaction, including account numbers and transaction amounts, the settlement decisioning engine further receiving communications including: transaction records at a settlement decisioning engine from an acquirer; and a settlement engine, including a processor and memory, the processor configured to determine for each received transaction record associated business criteria that is stored in a database coupled to the payment network system, with each received transaction record, based at least partially on merchant transaction information and settlement and matching criteria of a settlement window from a plurality of settlement windows with business criteria associated with a transaction record.

In one non-limiting embodiment or aspect, provided is a risk detection system for dynamically determining risk in a settlement window for a transaction between an acquirer and an issuer, the system including: a settlement decisioning engine, the settlement decisioning engine including: a processor and memory for storing a transaction, the transaction comprising information about a merchant transaction, including account numbers and transaction amounts, the settlement decisioning engine further receiving communications comprising transaction records at a settlement decisioning engine from an acquirer; a settlement engine, comprising a processor and memory, the processor configured to determine for each received transaction record, associated business criteria that is stored in a database coupled to the payment network system, with each received transaction record, based at least partially on merchant transaction information and settlement and matching criteria of a settlement window from a plurality of settlement windows with business criteria associated with a transaction record; and a risk analyzer testing the transactions of a settlement window before transmission to a settlement agency and/or an issuer, the risk analyzer capable of determining high-risk cases.

Further non-limiting embodiments or aspects will now be set forth in the following numbered clauses.

Clause 1: A computer-implemented method for dynamically designating a settlement window for a transaction within a settlement cycle between an acquirer and an issuer, the method comprising: receiving, by at least one processor, a plurality of transaction records associated with a plurality of transactions, wherein each transaction record comprises data associated with an account number of an account involved in a transaction associated with the transaction record, data associated with a transaction type of the transaction associated with the transaction record, and data associated with a transaction amount of the transaction associated with the transaction record; determining, by at least one processor, a first settlement window of a plurality of settlement windows to assign a transaction record of the plurality of transaction records based on settlement criteria of the first settlement window and at least one of the following: data associated with the account number of the account involved in the transaction associated with the transaction record, data associated with the transaction type of the transaction associated with the transaction record, data associated with the transaction amount of the transaction associated with the transaction record, or any combination thereof; assigning, by at least one processor, the transaction record of the plurality of transaction records to the first settlement window based on determining the first settlement window of the plurality of settlement windows to assign the transaction record; and performing, by at least one processor, a settlement function for a transaction associated with the transaction record assigned to the first settlement window based on assigning the transaction record of the plurality of transaction records to the first settlement window.

Clause 2: The computer-implemented method of claim 1, further comprising receiving a message, wherein the message comprises the plurality of transaction records.

Clause 3: The computer-implemented method of clause 1 or clause 2, wherein the message is a clearing message or an authorization message.

Clause 4: The computer-implemented method of any of clauses 1-3, wherein the settlement criteria of the first settlement window comprises data associated with settlement criteria of a jurisdiction.

Clause 5: The computer-implemented method of any of clauses 1-4, wherein the settlement criteria of the first settlement window is based at least partially on at least one of the following: transaction device type, transaction device category, product type, product category, transaction amount, transaction category, merchant type, merchant category, acquiring bank identification, issuing bank identification, country identification, jurisdiction identification, or any combination thereof.

Clause 6: The computer-implemented method of any of clauses 1-5, further comprising determining data associated with a transaction type of each transaction associated with each transaction record and matching each transaction record with a type of transaction based on the data associated with the transaction type of each transaction.

Clause 7: The computer-implemented method of any of clauses 1-6, wherein the type of transaction comprises at least one of: an on-us transaction type, a credit transaction type, a debit transaction type, or a merchant identification value transaction type.

Clause 8: The computer-implemented method of any of clauses 1-7, further comprising routing a clearing message to the issuer and calculating: a settlement obligation of the issuer associated with each transaction assigned to the first settlement window, and an amount due to the acquirer net fees and charges.

Clause 9: The computer-implemented method of any of clauses 1-8, further comprising performing risk protection on the first settlement window.

Clause 10: The computer-implemented method of any of clauses 1-9, further comprising: determining whether the transaction associated with the transaction record is associated with a risk parameter; and wherein performing the settlement function for the transaction associated with the transaction record assigned to the first settlement window comprises: blocking transmission of a settlement communication for the transaction record based on determining that the transaction record is a high-risk transaction record, or transmitting a settlement communication for the transaction record based on determining that the transaction associated with the transaction record is not a high-risk transaction record.

Clause 11: The computer-implemented method of any of clauses 1-10, further comprising receiving the settlement criteria of the first settlement window from an issuer that issued an account involved in a transaction of the plurality of transactions associated with the plurality of transactions.

Clause 12: The computer-implemented method of any of clauses 1-11, wherein the first settlement window is associated with a time period for settlement that is independent of an end of day time period for settlement.

Clause 13: The computer-implemented method of any of clauses 1-12, wherein each settlement window of the plurality of settlement windows is associated with a time period for settlement that is independent of an end of day time period for settlement.

Clause 14: The computer-implemented method of any of clauses 1-13, wherein performing the settlement function for the transaction associated with the transaction record assigned to the first settlement window comprises: facilitating a settlement communication for the transaction associated with the transaction record based on the first settlement window.

Clause 15: The computer-implemented method of any of clauses 1-14, wherein performing the settlement function for the transaction associated with the transaction record assigned to the first settlement window comprises: performing the settlement function for the transaction associated with the transaction record assigned to the first settlement window in real-time.

Clause 16: A system for dynamically designating a settlement window for a transaction within a settlement cycle between an acquirer and an issuer, comprising: at least one processor configured or programmed to: receive a plurality of transaction records associated with a plurality of transactions, wherein each transaction record comprises data associated with an account number of an account involved in a transaction associated with the transaction record, data associated with a transaction type of the transaction associated with the transaction record, and data associated with a transaction amount of the transaction associated with the transaction record; determine a first settlement window of a plurality of settlement windows to assign a transaction record of the plurality of transaction records based on settlement criteria of the first settlement window and at least one of the following: data associated with the account number of the account involved in the transaction associated with the transaction record, data associated with the transaction type of the transaction associated with the transaction record, data associated with the transaction amount of the transaction associated with the transaction record, or any combination thereof; assign the transaction record of the plurality of transaction records to the first settlement window based on determining the first settlement window of the plurality of settlement windows to assign the transaction record; and perform a settlement function for a transaction associated with the transaction record assigned to the first settlement window based on assigning the transaction record of the plurality of transaction records to the first settlement window.

Clause 17: The system of clause 16, further comprising receiving a message, wherein the message comprises the plurality of transaction records.

Clause 18: The system of clause 16 or clause 17, wherein the message is a clearing message or an authorization message.

Clause 19: The system of any of clauses 16-18, wherein the settlement criteria of the first settlement window comprises data associated with settlement criteria of a jurisdiction.

Clause 20: The system of any of clauses 16-19, wherein the settlement criteria of the first settlement window is based at least partially on at least one of the following: transaction device type, transaction device category, product type, product category, transaction amount, transaction category, merchant type, merchant category, acquiring bank identification, issuing bank identification, country identification, jurisdiction identification, or any combination thereof.

Clause 21: The system of any of clauses 16-20, wherein the at least one processor is further programmed or configured to: determine data associated with a transaction type of each transaction associated with each transaction record and matching each transaction record with a type of transaction.

Clause 22: The system of any of clauses 16-21, wherein the type of transaction comprises at least one of: an on-us transaction type, a credit transaction type, a debit transaction type, or a merchant identification value transaction type.

Clause 23: The system of any of clauses 16-22, wherein the at least one processor is further programmed or configured to: route a clearing message to the issuer; and calculate: a settlement obligation of the issuer associated with each transaction assigned to the first settlement window, and an amount due to the acquirer net fees and charges.

Clause 24: The system of any of clauses 16-23, wherein the at least one processor is further programmed or configured to: perform risk protection on the first settlement window.

Clause 25: The system of any of clauses 16-24, wherein the at least one processor is further programmed or configured to: determine whether the transaction associated with the transaction record is associated with a risk parameter; and wherein, when performing the settlement function for the transaction associated with the transaction record assigned to the first settlement window, the at least one processor is programmed or configured to: block transmission of a settlement communication for the transaction record based on determining that the transaction record is a high-risk transaction record, or transmit a settlement communication for the transaction record based on determining that the transaction associated with the transaction record is not a high-risk transaction record.

Clause 26: The system of any of clauses 16-25, wherein the at least one processor is further programmed or configured to: receive the settlement criteria of the first settlement window from an issuer that issued an account involved in a transaction of the plurality of transactions associated with the plurality of transactions.

Clause 27: The system of any of clauses 16-26, wherein the first settlement window is associated with a time period for settlement that is independent of an end of day time period for settlement.

Clause 28: The system of any of clauses 16-27, wherein each settlement window of the plurality of settlement windows is associated with a time period for settlement that is independent of an end of day time period for settlement.

Clause 29: The system of any of clauses 16-28, wherein, when performing the settlement function for the transaction associated with the transaction record assigned to the first settlement window, the at least one processor is programmed or configured to: facilitate a settlement communication for the transaction associated with the transaction record based on the first settlement window.

Clause 30: The system of any of clauses 16-29, wherein, when performing the settlement function for the transaction associated with the transaction record assigned to the first settlement window, the at least one processor is programmed or configured to: perform the settlement function for the transaction associated with the transaction record assigned to the first settlement window in real-time.

Clause 31: A computer-implemented method for dynamically designating a preferred settlement window for a transaction within a settlement cycle between an acquirer and an issuer, the method comprising: receiving communications comprising transaction records at a settlement decisioning engine from an acquirer, the settlement decisioning engine having a processor and memory that stores a transaction record comprising information about a merchant transaction, including account numbers and transaction amounts; for each received transaction record, generating and associating business criteria with each received transaction based at least partially on the merchant transaction information, acquirer processing information, and settlement preferences; matching criteria of a settlement window from a plurality of settlement windows with business criteria associated with a transaction record; and transmitting the matched transaction records to the participating issuers based upon their processing and settlement preferences as part of a settlement.

Clause 32: The computer-implemented method of clause 31, the communications comprising a clearing message or an authorization message.

Clause 33: The computer-implemented method of clause 31 or clause 32, the settlement including multiple settlement transactions.

Clause 34: The computer-implemented method of any of clauses 31-33, the criteria of the settlement window comprising jurisdictions, each jurisdiction associated with a flexible set of settlement rules.

Clause 35: The computer-implemented method of any of clauses 31-34, wherein generating business criteria further comprises matching each record with a type of transaction from the set comprising on-us, credit, debit, and merchant identification value.

Clause 36: The computer-implemented method of any of clauses 31-35, wherein the settlement decisioning engine routes the clearing message to the card issuer and calculates the settlement obligation of the issuer and the amount due to the acquirer, net of certain applicable fees and charges.

Clause 37: The computer-implemented method of any of clauses 31-36, wherein anomalies, comprising transaction volumes or dollar values in a settlement window, causes withholding of settlement, and removing high-risk records before sending.

Clause 38: A non-transitory computer readable medium with computer executable instructions stored thereon executed by a processor to perform the method of dynamically designating a preferred settlement window for a transaction within a settlement cycle between an acquirer and an issuer, the method comprising: receiving communications comprising transaction records at a settlement decisioning engine from an acquirer, the settlement decisioning engine having a processor and memory that stores a transaction record comprising information about a merchant transaction, including account numbers and transaction amounts; for each received transaction record, generating and associating business criteria with each received transaction based at least partially on the merchant transaction information, acquirer processing information, and settlement preferences; matching criteria of a settlement window from a plurality of settlement windows with business criteria associated with a transaction record; and transmitting matched transaction records to the participating issuers based upon their processing and settlement transactions as part of a settlement.

Clause 39: A payment network system for dynamically designating a preferred settlement window for a transaction within a settlement cycle between an acquirer and an issuer, the method comprising: a settlement decisioning engine, the settlement decisioning engine comprising a processor and memory for storing a transaction, the transaction comprising information about a merchant transaction, including account numbers and transaction amounts, the settlement decisioning engine further receiving communications comprising transaction records at a settlement decisioning engine from an acquirer; a settlement engine, comprising a processor and memory, the processor configured to determine for each received transaction record, associated business criteria that is stored in a database coupled to the payment network system, with each received transaction record, based at least partially on merchant transaction information, acquirer processing information, and settlement preferences, and matching criteria of a settlement window from a plurality of settlement windows with business criteria associated with a transaction record; and wherein the settlement decisioning engine, is further configured to transmit a settlement record at a preprogrammed time.

Clause 40: A risk detection system for dynamically determining risk in a settlement window for a transaction between an acquirer and an issuer, the system comprising: a settlement decisioning engine, the settlement decisioning engine comprising a processor and memory for storing a transaction, the transaction comprising information about a merchant transaction, including account numbers and transaction amounts, the settlement decisioning engine further receiving communications comprising transaction records at a settlement decisioning engine from an acquirer; a settlement engine, comprising a processor and memory, the processor configured to determine for each received transaction record, associated business criteria that is stored in a database coupled to the payment network system, with each received transaction record, based at least partially on merchant transaction information, acquirer processing information, and settlement preferences, and matching criteria of a settlement window from a plurality of settlement windows with business criteria associated with a transaction record; and a risk analyzer testing the transactions of a settlement window before transmission to a settlement agency and/or an issuer, the risk analyzer capable of determining high-risk cases.

Clause 41: A computer-implemented settlement method, comprising: (a) generating a plurality of settlement positions for a plurality of transactions; (b) assigning each of the plurality of transactions to a specified settlement position; and (c) facilitating a settlement communication for each of the plurality of transactions based on the assigned settlement position.

Clause 42: The method of clause 41, further comprising assigning each of the plurality of transactions to at least one settlement category, wherein the specified settlement position for each of the plurality of transactions is assigned based at least partially on the settlement category.

Clause 43. The method of clause 41 or clause 42, wherein each of the settlement categories is generated based at least partially on at least one of the following: transaction device type, transaction device category, product type, product category, transaction amount, transaction category, merchant type, merchant category, acquiring bank identification, issuing bank identification, country identification, jurisdiction identification, or any combination thereof.

Clause 44: The method of any of clauses 41-43, further comprising: determining a plurality of available specified settlement positions for at least one transaction; and assigning an optimal settlement position for the at least one transaction.

Clause 45: The method of any of clauses 41-44, wherein the optimal settlement position is selected at least partially based on at least one of the following: an acquiring bank selection, an issuing bank selection, a merchant selection, a transaction processing server selection, a configurable selection, a ranking, a weight, or any combination thereof.

Clause 46: The method of any of clauses 41-45, wherein the optimal settlement position is determined at least partially based on content of at least one of the following: a payment authorization message, a clearing message, or any combination thereof.

Clause 47: The method of any of clauses 41-46, wherein at least one settlement position of the plurality of settlement positions is generated at least partially based upon an agreement between at least one acquiring bank and at least one issuing bank.

Clause 48: The method of any of clauses 41-47, wherein assigning each of the plurality of transactions to a specified settlement position comprises applying a plurality of settlement rules to each transaction.

Clause 49: The method of any of clauses 41-48, wherein the plurality of settlement rules are applied on at least one of the following: a dynamic basis, a static basis, a variable basis, or any combination thereof.

Clause 50: The method of any of clauses 41-49, further comprising applying a plurality of risk detection rules to each of a plurality of transactions in the specified settlement position.

Clause 51: The method of any of clauses 41-50, wherein facilitating a settlement communication for each of the plurality of transactions based on the assigned settlement position is implemented for the plurality of transaction in the specified settlement position if no risk is detected by the plurality of risk detection rules.

Clause 52: The method of any of clauses 41-51, wherein the risk detection rules are applied prior to implementing step (c).

Clause 53: The method of any of clauses 41-52, comprising matching each of the settlement positions of an established settlement position of at least one settlement service.

Clause 54: A computer-implemented method for dynamically designating a settlement window for a transaction within a settlement cycle between an acquirer and an issuer, the method comprising: receiving, by at least one processor, a plurality of transaction records associated with a plurality of transactions, wherein each transaction record comprises data associated with an account number of an account involved in a transaction associated with the transaction record, data associated with a transaction type of the transaction associated with the transaction record, data associated with a transaction amount of the transaction associated with the transaction record; determining, by at least one processor, a first settlement window of a plurality of settlement windows to assign a transaction record of the plurality of transaction records based on settlement criteria of the first settlement window and at least one of the following: data associated with the account number of the account involved in the transaction associated with the transaction record, data associated with the transaction type of the transaction associated with the transaction record, data associated with the transaction amount of the transaction associated with the transaction record, or any combination thereof; assigning, by at least one processor, the transaction record of the plurality of transaction records to the first settlement window based on determining the first settlement window of the plurality of settlement windows to assign the transaction record; performing, by at least one processor, a settlement function for a transaction associated with the transaction record assigned to the first settlement window based on assigning the transaction record of the plurality of transaction records to the first settlement window.

Clause 55: The computer-implemented method of clause 54, further comprising receiving a message, wherein the message comprises the plurality of transaction records.

Clause 56: The computer-implemented method of clause 54 or clause 55, wherein the message is a clearing message or an authorization message.

Clause 57: The computer-implemented method of any of clauses 54-56, wherein the settlement criteria of the first settlement window comprises data associated with settlement criteria of a jurisdiction.

Clause 58: The computer-implemented method of any of clauses 54-57, wherein the settlement criteria of the first settlement window is based at least partially on at least one of the following: transaction device type, transaction device category, product type, product category, transaction amount, transaction category, merchant type, merchant category, acquiring bank identification, issuing bank identification, country identification, jurisdiction identification, or any combination thereof.

Clause 59: The computer-implemented method of any of clauses 54-58, further comprising determining data associated with a transaction type of each transaction associated with each transaction record and matching each transaction record with a type of transaction based on the data associated with the transaction type of each transaction.

Clause 60: The computer-implemented method of any of clauses 54-59, wherein the type of transaction comprises at least one of: an on-us transaction type, a credit transaction type, a debit transaction type, or a merchant identification value transaction type.

Clause 61: The computer-implemented method of any of clauses 54-60, further comprising routing a clearing message to an issuer and calculating: a settlement obligation of the issuer associated with each transaction assigned to the first settlement window, and an amount due to an acquirer net fees and charges.

Clause 62: The computer-implemented method of any of clauses 54-61, further comprising performing risk protection on the first settlement window.

Clause 63: The computer-implemented method of any of clauses 54-62, further comprising: determining whether the transaction associated with the transaction record is associated with a risk parameter; and wherein performing the settlement function for the transaction associated with the transaction record assigned to the first settlement window comprises: blocking transmission of a settlement communication for the transaction record based on determining that the transaction record is a high-risk transaction record, or transmitting a settlement communication for the transaction record based on determining that the transaction associated with the transaction record is not a high-risk transaction record.

Clause 64: The computer-implemented method of any of clauses 54-63, receiving the settlement criteria of the first settlement window from an issuer that issued an account involved in a transaction of the plurality of transactions associated with the plurality of transaction.

Clause 65: The computer-implemented method of any of clauses 54-64, wherein the first settlement window is associated with a time period for settlement that is independent of an end of day time period for settlement.

Clause 66: The computer-implemented method of any of clauses 54-65, wherein each settlement window of the plurality of settlement windows is associated with a time period for settlement that is independent of an end of day time period for settlement.

Clause 67: The computer-implemented method of any of clauses 54-66, wherein performing the settlement function for the transaction associated with the transaction record assigned to the first settlement window comprises: facilitating a settlement communication for the transaction associated with the transaction record based on the first settlement window.

Clause 68: The computer-implemented method of any of clauses 54-67, wherein performing the settlement function for the transaction associated with the transaction record assigned to the first settlement window comprises: performing the settlement function for the transaction associated with the transaction record assigned to the first settlement window in real-time.

Clause 69: A system for dynamically designating a settlement window for a transaction within a settlement cycle between an acquirer and an issuer, comprising: at least one processor configured or programmed to: receive a plurality of transaction records associated with a plurality of transactions, wherein each transaction record comprises data associated with an account number of an account involved in a transaction associated with the transaction record, data associated with a transaction type of the transaction associated with the transaction record, data associated with a transaction amount of the transaction associated with the transaction record; determine a first settlement window of a plurality of settlement windows to assign a transaction record of the plurality of transaction records based on settlement criteria of the first settlement window and at least one of the following: data associated with the account number of the account involved in the transaction associated with the transaction record, data associated with the transaction type of the transaction associated with the transaction record, data associated with the transaction amount of the transaction associated with the transaction record, or any combination thereof; assign the transaction record of the plurality of transaction records to the first settlement window based on determining the first settlement window of the plurality of settlement windows to assign the transaction record; perform a settlement function for a transaction associated with the transaction record assigned to the first settlement window based on assigning the transaction record of the plurality of transaction records to the first settlement window.

Clause 70: The system of clause 69, further comprising receiving a message, wherein the message comprises the plurality of transaction records.

Clause 71: The system of clause 69 or clause 70, wherein the message is a clearing message or an authorization message.

Clause 72: The system of any of clauses 69-71, wherein the settlement criteria of the first settlement window comprises data associated with settlement criteria of a jurisdiction.

Clause 73: The system of any of clauses 69-72, wherein the settlement criteria of the first settlement window is based at least partially on at least one of the following: transaction device type, transaction device category, product type, product category, transaction amount, transaction category, merchant type, merchant category, acquiring bank identification, issuing bank identification, country identification, jurisdiction identification, or any combination thereof.

Clause 74: The system of any of clauses 69-73, wherein the at least one processor is further programmed for configured to: determine data associated with a transaction type of each transaction associated with each transaction record and matching each transaction record with a type of transaction.

Clause 75: The system of any of clauses 69-74, wherein the type of transaction comprises at least one of: an on-us transaction type, a credit transaction type, a debit transaction type, or a merchant identification value transaction type.

Clause 76: The system of any of clauses 69-75, wherein the at least one processor is further programmed for configured to: route a clearing message to an issuer; and calculate: a settlement obligation of the issuer associated with each transaction assigned to the first settlement window, and an amount due to an acquirer net fees and charges.

Clause 77: The system of any of clauses 69-76, wherein the at least one processor is further programmed for configured to: perform risk protection on the first settlement window.

Clause 78: The system of any of clauses 69-77, wherein the at least one processor is further programmed for configured to: determine whether the transaction associated with the transaction record is associated with a risk parameter; and wherein, when performing the settlement function for the transaction associated with the transaction record assigned to the first settlement window, the at least one processor is programmed or configured to: block transmission of a settlement communication for the transaction record based on determining that the transaction record is a high-risk transaction record, or transmit a settlement communication for the transaction record based on determining that the transaction associated with the transaction record is not a high-risk transaction record.

Clause 79: The system of any of clauses 69-78, wherein the at least one processor is further programmed for configured to: receive the settlement criteria of the first settlement window from an issuer that issued an account involved in a transaction of the plurality of transactions associated with the plurality of transaction.

Clause 80: The system of any of clauses 69-79, wherein the first settlement window is associated with a time period for settlement that is independent of an end of day time period for settlement.

Clause 81: The system of any of clauses 69-80, wherein each settlement window of the plurality of settlement windows is associated with a time period for settlement that is independent of an end of day time period for settlement.

Clause 82: The system of any of clauses 69-81, wherein, when performing the settlement function for the transaction associated with the transaction record assigned to the first settlement window, the at least one processor is programmed or configured to: facilitate a settlement communication for the transaction associated with the transaction record based on the first settlement window.

Clause 83: The system of any of clauses 69-82, wherein, when performing the settlement function for the transaction associated with the transaction record assigned to the first settlement window, the at least one processor is programmed or configured to: perform the settlement function for the transaction associated with the transaction record assigned to the first settlement window in real-time.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a,” “an,” and “the” include plural referents unless the context clearly dictates otherwise.

### BRIEF DESCRIPTION OF THE DRAWINGS

Additional advantages and details of the invention are explained in greater detail below with reference to the exemplary embodiments that are illustrated in the accompanying schematic figures, in which:

FIG. 1 is a payment network block diagram according to the present invention;

FIG. 2 is a settlement payment flow diagram illustrating multiple settlement positions or windows according to the present invention;

FIG. 3A is a flow diagram illustrating a clearing and settlement system according to the present invention;

FIG. 3B is a flow diagram illustrating an existing clearing and settlement system;

FIG. 4A is a flow diagram illustrating an existing risk management process;

FIG. 4B is a flow diagram illustrating a risk management process according to the present invention;

FIG. 5 is a step diagram for generating a plurality of settlement windows according to the present invention; and

FIG. 6 is a step diagram showing a method of risk detection according to the present invention.

### DESCRIPTION OF THE PREFERRED EMBODIMENTS

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments or aspects of the invention. Hence, specific dimensions and other physical characteristics related to the embodiments or aspects disclosed herein are not to be considered as limiting.

As used herein, the terms “communication” and “communicate” refer to the receipt or transfer of one or more signals, messages, commands, or other type of data. For one unit (e.g., any device, system, or component thereof) to be in communication with another unit means that the one unit is able to directly or indirectly receive data from and/or transmit data to the other unit. This may refer to a direct or indirect connection that is wired and/or wireless in nature. Additionally, two units may be in communication with each other even though the data transmitted may be modified, processed, relayed, and/or routed between the first and second unit. For example, a first unit may be in communication with a second unit even though the first unit passively receives data and does not actively transmit data to the second unit. As another example, a first unit may be in communication with a second unit if an intermediary unit processes data from one unit and transmits processed data to the second unit. It will be appreciated that numerous other arrangements are possible.

As used herein for the purposes of describing the present invention and its various embodiments and aspects, the terms “transaction,” “transaction records,” and derivatives thereof refer to transactions and transaction records involving debit and/or credit cards unless otherwise provided. However, it is to be understood that other types of transactions are also contemplated consistent with the scope and spirit of the appended claims.

Non-limiting embodiments or aspects of the present invention are directed to a system and method for processing funds settlements. Embodiments or aspects of the present invention provide the technological environment and infrastructure for implementing, managing, controlling, or otherwise processing funds settlements for transactions between issuers and acquirers. Further embodiments or aspects of the present invention facilitate the processing, managing, or otherwise controlling a computer-implemented method for dynamically designating a preferred settlement position or settlement window for a transaction within a settlement cycle between an acquirer and an issuer. Still further embodiments or aspects of the present invention provide the technological environment and infrastructure for implementing, managing, controlling, or otherwise processing a payment network system for dynamically designating a preferred settlement position or window for a transaction within a settlement cycle between an acquirer and an issuer.

In this way, embodiments or aspects of the present invention provide a preferred settlement window that allows for flexibility based on the individual needs of participants of a transaction processing system. A preferred settlement window does not tie up funds until the predetermined settlement time, but instead allows for settlement of a transaction to be carried out by specified criteria. This may alleviate burdens for some participants, for example, acquirers who pre-fund merchants. Additionally, embodiments or aspects of the present invention reduce complications associated with the movement of funds when potentially high-risk activity is detected.

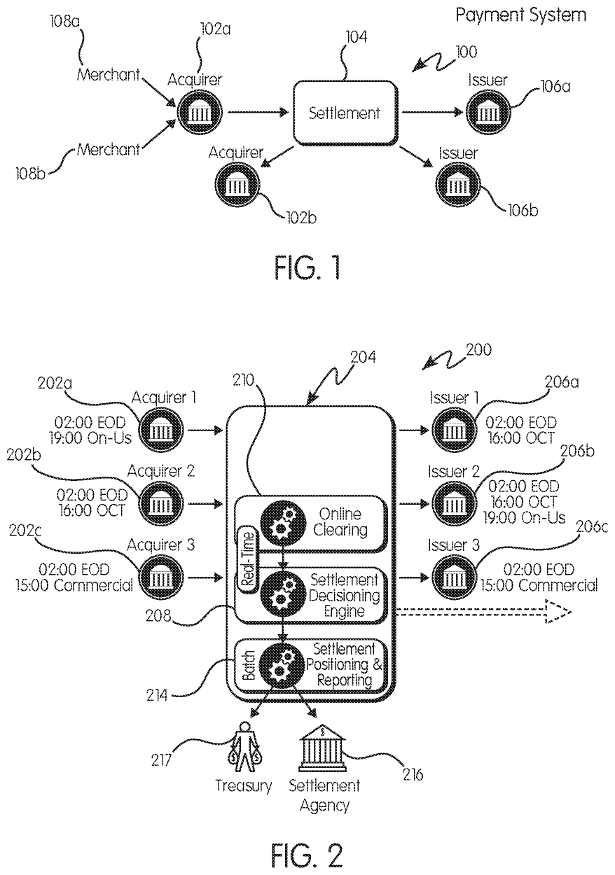

With reference to FIG. 1, a payment system 100 is illustrated, providing a network for clearing and settling merchant transactions. In a payment network, an acquirer 102a routes payment information associated with transaction records to a settlement system 104. The settlement system 104 operates on or analyzes the transactions to determine issuer information and other information about the transaction. The transaction is then routed to an issuer 106a. Transaction processing involves the routing of payment information and related data to facilitate the authorization, clearing, and settlement of transactions between issuers, which are the financial institutions that issue credit cards to cardholders, and acquirers, which are the financial institutions that offer network connectivity and payment acceptance services to merchants, e.g., the merchant's bank.

Authorization is the process of approving or declining a transaction before a purchase is finalized or cash is disbursed. Clearing is the process of delivering final transaction data from acquirer 102a to issuer 106a for posting to the cardholder's account, the calculation of certain fees and charges that apply to the issuer and acquirer involved in the transaction, and the conversion of transaction amounts to the appropriate settlement currencies. Settlement is the process of calculating, determining, reporting, and transferring the net financial position of issuers and acquirers for all transactions that are cleared. The payment network can comprise multiple acquirers 102a and 102b, multiple issuers 106a and 106b, and multiple merchants 108a and 108b.

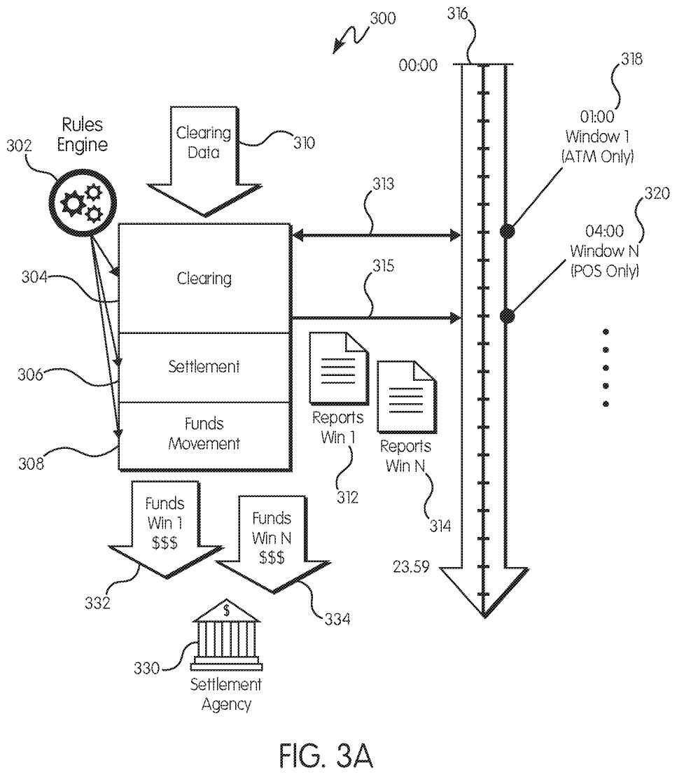

Referring now to FIG. 2, a payment settlement network 200 is illustrated, showing a non-limiting embodiment or aspect of the present invention. A plurality of acquirers 202a, 202b, 202c and issuers 206a, 206b, 206c are shown, each coupled to a payment system 204 to send a plurality of communications to a real-time settlement decisioning engine 208. The acquirers 202a-202c and communications may have a one-to-one or one-to-many correspondence. That is, each acquirer 202a-202c may send one or more communications depending on how many transactions need to be settled for that acquirer 202a-202c. Each of the one or more communications contains associated information sent to the real-time settlement engine 208. Each of the one or more communications may be a transaction record including information regarding a merchant transaction, such as account numbers, transaction amounts, and other information necessary for settlement of the transaction records. In some embodiments, the real-time settlement engine 208 includes at least one processor and memory capable of storing the transaction records.

The real-time settlement decisioning engine 208 comprises rules for business and settlement. As merchant transaction records are received by the payment system 204, they are analyzed, divided, and assigned into a plurality of settlement positions or windows based on predetermined business and settlement rules.

The business rules are part of an online clearing module 210, and operate using any of the following: information associated with a transaction record; information regarding a merchant transaction, such as account numbers and/or transaction amounts; other information necessary for settlement of the transaction records; or any combination thereof.

The settlement decisioning engine 208 operates to set a criteria for determining when each transaction record is settled, based on predetermined criteria, in the form of business rules or settlement rules, and programmed into the settlement decisioning engine 208 by a settlement decision system administrator.

Once the transaction records are assigned to the plurality of settlement windows, each settlement position or window is individually cleared and settled by the settlement decisioning engine 208 at a predetermined time corresponding to each of the plurality of settlement windows. The transaction payments are then sent to the plurality of issuers 206a-206c. In this manner, transaction records may be settled between the plurality of acquirers 202a-202c and the plurality of issuers 206a-206c.

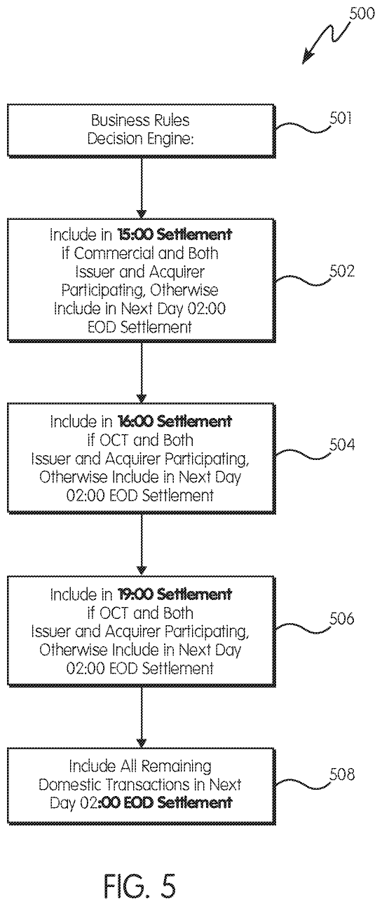

For example, business rules can be introduced by the clearing system 210 to the incoming transaction record data to determine a type of transaction for a specified transaction record. The settlement decisioning engine 208 then matches transaction records having like characteristics as determined by the business rule, as described in reference to FIG. 5. For example, transaction records, which include a commercial payment may be assigned to a first settlement window (15:00 Settlement). Transaction records which include a person-to-person (or original credit transaction (OCT)) payment may be assigned to a second settlement window (16:00 Settlement). Transaction records which include a payment between the same banking entity (on-us) may be assigned to a third settlement window (15:00 Settlement). Finally, domestic transaction records which do not fit in any one of the above categories are assigned to a fourth settlement window (02:00 EOD Settlement).

Once the clearing and settlement process has completed, the payment settlement network, via a treasury function, will provide net settlement instructions to a settlement agency 216 to debit and credit the issuers 206a-206c and the acquirers 202a-202c via their respective accounts with the settlement agency 216.

The business rules are not limited to those shown in FIG. 2. For example, a business rule automatically assigns transaction records involving cardholders to the next available transaction window so that transactions are settled faster for cardholders. Another business rule may assign transaction records to settlement windows based on the value of the underlying transaction. Further individual acquirers and issuers may enter bilateral agreements to have all transaction records between them assigned to a predetermined settlement window. Further, each settlement position or window may be assigned to a settlement category, which may be generated based at least partially on at least one of the following: transaction device type, transaction device category, product type, product category, transaction amount, transaction category, merchant type, merchant category, acquiring bank identification, issuing bank identification, country identification, jurisdiction identification, or any combination thereof.

In some embodiments, the business rules are made by the administrator of the settlement decisioning engine 208. Business rules may be mandatory or optional, as determined by the administrator of the settlement decisioning engine 208. Mandatory rules assign settlement windows to transaction records without specific consent of either the acquirers 202a-20c or issuers 206a-206c. Optional rules, such as bilateral agreements between individual acquirers 202a-202c and issuers 206a-206c, may then be opted into by individual acquirers and/or issuers.

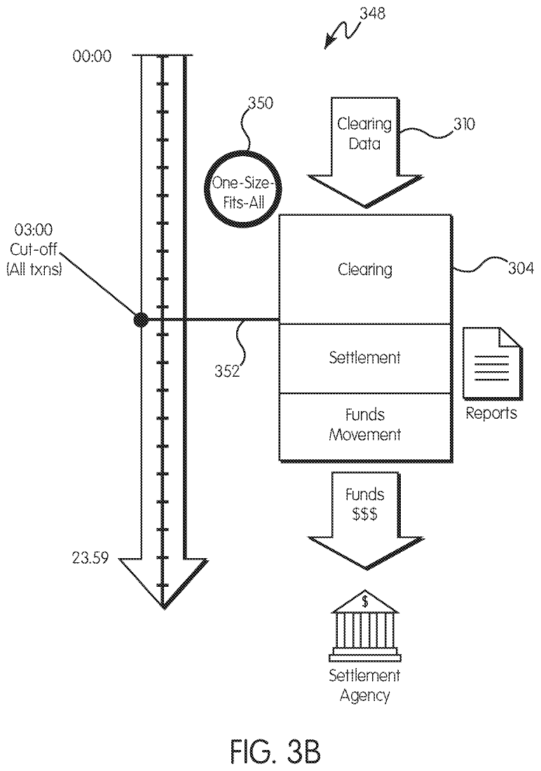

Referring now to FIG. 3A, a flow diagram of an embodiment of a clearing and settlement system 300 is illustrated. A rules engine 302 is programmed or configured to handle the processes of clearing 304, settlement 306, and funds movement 308. As clearing data 310 is received, the clearing and settlement system 300 processes clearing transactions based upon applicable rules established in the rules engine 302, and processes the clearing transactions within or using matching criteria in potentially different settlement windows 313, 315. Each settlement window 313, 315 corresponds to a settlement rule, and, accordingly, transaction records are assigned to each of the plurality of settlement windows 313, 315 based on the business information and settlement rules for each of the plurality of settlement windows 313, 315. Settlement reports 312, 314 are then generated for each of the settlement windows 313, 315. The transaction records assigned to each settlement window 313, 315 are cleared and settled separately from the transaction records of the remaining settlement windows. During clearing and settlement corresponding to each settlement window 313, 315, the transaction records associated with that settlement window are processed by the rules engine 302. If a potentially high-risk transaction record is detected during the clearing process, that transaction record is withdrawn and the remaining transaction records in that settlement window are recast and the clearing and settlement process is performed on the recast transaction records. However, because the total number of transactions is spread out among the plurality of settlement windows 313, 315, there are less transaction records processed in each settlement window 313, 315. As a result, processing transaction records takes less time than existing systems, resulting in less processing delays. Further, detection of a high-risk transaction record in one of the plurality of settlement windows 313, 315 has no effect on the processing of transaction records in the remaining settlement windows 313, 315.

The settlement reports 312, 314 are forwarded after risk detection if each transaction record passes a risk test. The settlement windows 313, 315 are illustrated along a timeline 316, having times of 01:00 at a first settlement window 318 and 04:00 at a second settlement window 320. The first settlement window 318 is assigned ATM transactions, and the second settlement window 320 is assigned point-of-sale (“POS”) transactions. At the end of each settlement window 313, 315, the clearing and settlement system 300 sends funds transfer instructions 332, 334 to a settlement agency 330 so that the acquirers and issuers may be debited and credited accordingly.

With continued reference to FIG. 3A, the first settlement window 318 is programmed a cut-off time of 01:00. At time 01:00, all transaction records for underlying transactions completed at an ATM are processed, cleared, and settled. Settlement reports 312 for all transaction records assigned to the first settlement window 318 are generated. Similarly, the second settlement window 320 is programmed with a cut-off time of 04:00. At time 04:00, all transaction records for underlying transactions completed at a POS are processed, cleared, and settled. Settlement reports 314 for all transaction records assigned to the second settlement window 320 are generated.

With reference to FIG. 3B, an existing clearing and settlement system 348 has only a single settlement window 352. All transactions occurring in a predetermined time period are received as clearing data 310 and processed through clearing 304. Typically, the predetermined time period is one day. Therefore, all transaction records generated each day are cleared and settled in one settlement window 352 based on a single, one-size-fits-all rule 350. Having a single settlement window 352 provides no option for expedited settlement of transaction records. Rather, all transaction records submitted in a day before the cut-off time are cleared and settled in the same window 352 using a single batch. Transactions submitted after the cut-off time are processed in the next day's settlement window. Additionally, having a single settlement window 352 may result in settlement delays caused by the detection of high-risk transaction records. When a potentially high-risk transaction record is detected, that transaction record is withdrawn from the settlement process, and remaining, non-high-risk transaction records must be re-processed. The clearing and settlement process is then repeated for the re-processed transaction records. The process of withdrawing potentially high-risk transaction records and re-processing (or recasting) of the non-high-risk transaction records may cause substantial delay in the settlement of all transaction records generated for the predetermined time period. For example, settlement may not be able to be completed for one to two days due to the large number of transaction records processed in the single settlement window 352.

Typically, jurisdictional or geographical information is used to create a single settlement window process and all transaction records for domestic transactions in smaller countries. Transaction records for the single settlement window can be generated until a predetermined cut-off time, for example, 03:00 as shown in FIG. 3B. Transaction records generated after the cut-off time are assigned to the settlement window for the next day. Within the settlement decisioning engine, one or more reports are generated based on the transaction records. The one or more reports are then audited for potentially high-risk transaction records. The clearing and settlement process is then completed accordingly. In contrast, in the embodiment shown in FIG. 3A, multiple windows can be offered, providing settlement earlier for many more transactions.

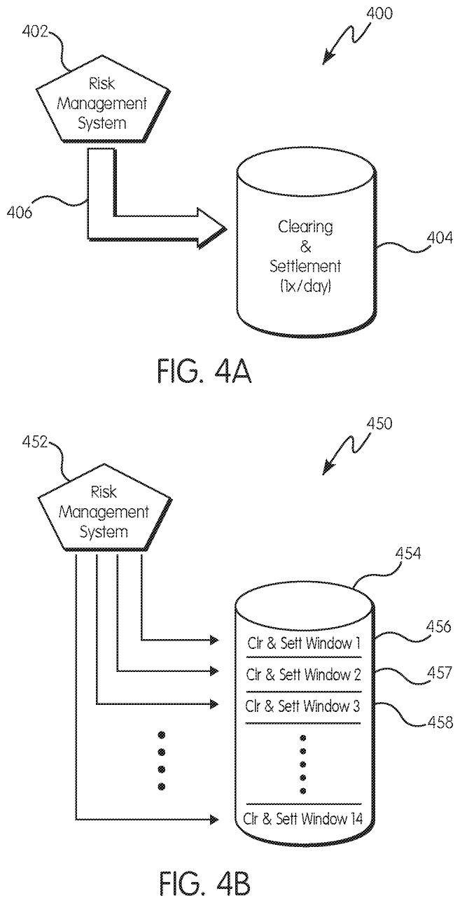

Referring now to FIG. 4A, an existing risk management process 400 that accompanies the settlement process is illustrated. The existing risk management system includes a risk management system 402 having a single one-size-fits-all or fixed procedure for clearing and settlement 404, resulting in a single settlement window 406.

Referring now to FIG. 4B, one non-limiting embodiment or aspect of a multi-window settlement and clearing system 450 is illustrated. The system 450 includes a risk management system 452 coupled to a data ecosystem having multiple business rules for assigning each transaction record to one of the plurality of settlement windows 456-458. Each of the plurality of settlement windows 456-458, i.e., Win 1 . . . Win 3, has predetermined cut-off times, which are also preprogrammed into the settlement decisioning engine. Once the cut-off time for one of the plurality of settlement windows is reached, the transaction records assigned to that settlement window are cleared and settled by the settlement decisioning engine. One or more reports is generated for the transaction records assigned to that settlement window, and the reports are audited for potentially high-risk transactions. If detected, potentially high-risk transaction records are withdrawn and the remaining transactions are recast until all the transaction records assigned to that settlement window are cleared and settled. The clearing and settlement process is repeated for each of the plurality of settlement windows once the cut-off time for the associated settlement window is reached.

With reference to FIG. 5, a step diagram 500 for generating a plurality of settlement positions for a plurality of transactions is illustrated. At step 501, the system considers the transaction and associated information based on the business rules associated with the decisioning engine. The system determines information about the transaction that it can use to determine handling requirements for a settlement. In a first instance, the credit card is commercial and both the issuer and acquirer are participating in the settlement. At step 502, the system includes the transaction in a first 15:00 settlement window, otherwise the transaction placed in the settlement window for the following day EOD settlement. Using the same or the next transaction in the queue, the system then considers the next transaction and associated information. The system determines at step 504 if the transaction credit card is an OCT, and both the issuer and acquirer are participating in the settlement and include the transaction in a settlement window at 16:00. Otherwise, the transaction is placed in the settlement window for the following day EOD settlement. The system determines at step 506 if the transactions credit card is an OCT and both the issuer and acquirer are participating in the settlement and includes the transaction in a settlement window at 19:00. Otherwise the transaction is placed in settlement window for the following day EOD settlement. Finally, at step 508 all remaining domestic transactions are placed in a settlement for the next EOD settlement.

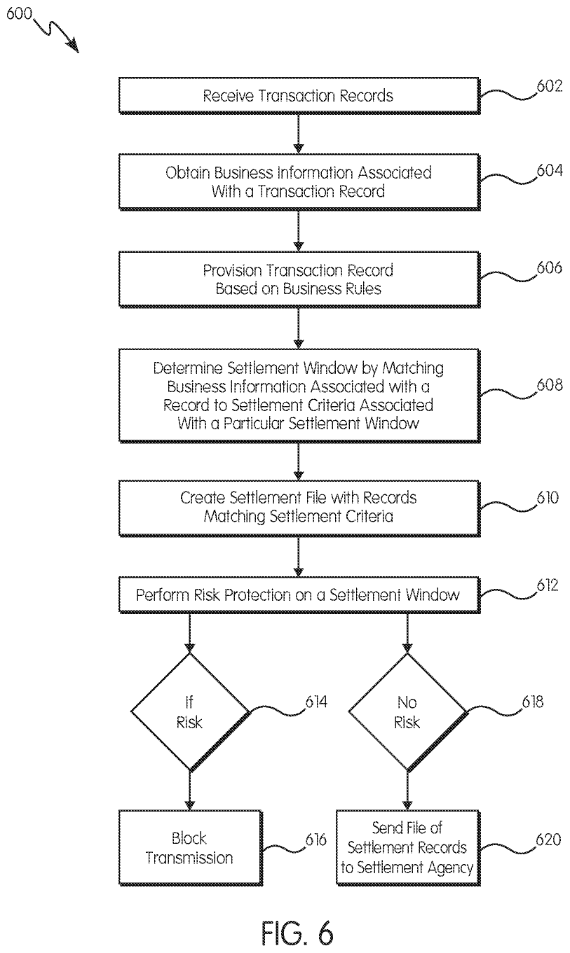

With reference to FIG. 6, a method of risk protection 600 is illustrated for assigning each of a plurality of transactions to a specified settlement position or settlement window. The method 600 is for facilitating a settlement communication for each of the plurality of transactions based on the assigned settlement position and risk protections for each designated settlement window. At step 602, the system receives a plurality of transaction records. For example, the system may receive a stream of transaction records from an acquirer. At step 604, the system delegates assignments for each of the plurality of transactions to a specified settlement position or settlement window. The assignments may include applying a plurality of settlement rules having settlement criteria to each transaction record. The plurality of settlement rules may be applied based on at least one of the following: a dynamic basis, a static basis, a variable basis, or any combination thereof. At step 606, the system may provision a transaction record based on business rules. At step 608, the system may determine a settlement position or settlement window by matching information associated with a transaction record to a settlement rule associated with the settlement position or settlement window, where the settlement rule has settlement criteria. In some embodiments or aspects, the system determines a settlement window of a plurality of settlement windows by matching business information associated with a record to settlement criteria associated with a particular settlement window.

At step 610, the system creates settlement files with transaction records matching settlement criteria. In some embodiments, the system may assign each of a plurality of transaction records to at least one settlement category, wherein the specified settlement position or settlement window for each of the plurality of transaction records is assigned based at least partially on the settlement category. Each of the settlement categories may be generated based at least partially on at least one of the following: transaction device type, transaction device category, product type, product category, transaction amount, transaction category, merchant type, merchant category, acquiring bank identification, issuing bank identification, country identification, jurisdiction identification, or any combination thereof. In some embodiments, each of the settlement categories may be associated with each settlement position of a plurality of settlement positions or each settlement window of a plurality of settlement windows.

In some embodiments, the system may determine a plurality of available specified settlement positions for at least one transaction and assign an optimal settlement position for the at least one transaction. The optimal settlement position may be selected at least partially based on at least one of the following: an acquiring bank selection, an issuing bank selection, a merchant selection, a transaction processing server selection, a configurable selection, a ranking, a weight, or any combination thereof. Alternatively, or in addition to, the optimal settlement position may be determined at least partially based on content of at least one of the following: a payment authorization message, a clearing message, or any combination thereof. At least one settlement position of the plurality of settlement positions may be generated at least partially based on an agreement between at least one acquiring bank and at least one issuing bank.

At step 612, the system may apply a plurality of risk detection rules to each of a plurality of transactions in the specified settlement position. At step 614, the system may facilitate a settlement communication for each of the plurality of transactions based on the assigned settlement position or assigned settlement window. At step 616, the system can perform risk protection. For example, the system may block a settlement window file from transmission when it contains a high-risk transaction at step 616. The record is reconciled along with alternative tests which may be conducted on the other transactions contained in the settlement window. For the plurality of transactions in the specified settlement position, if no risk is detected at 618 by the plurality of risk detection rules, the settlement is transmitted at 620. Alternatively, the risk detection rules may be applied prior to facilitating a settlement communication for each of the plurality of transactions based on the assigned settlement position.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

1. A computer-implemented method for dynamically designating a settlement window for a transaction within a settlement cycle between an acquirer and an issuer, the method comprising:
receiving, by at least one processor, a plurality of transaction records associated with a plurality of transactions, wherein each transaction record comprises data associated with an account number of an account involved in a transaction associated with the transaction record, data associated with a transaction type of the transaction associated with the transaction record, and data associated with a transaction amount of the transaction associated with the transaction record;
determining, by at least one processor, a first settlement window of a plurality of settlement windows to assign a transaction record of the plurality of transaction records based on settlement criteria of the first settlement window and at least one of the following:
data associated with the account number of the account involved in the transaction associated with the transaction record,
data associated with the transaction type of the transaction associated with the transaction record,
data associated with the transaction amount of the transaction associated with the transaction record, or
any combination thereof;
assigning, by at least one processor, the transaction record of the plurality of transaction records to the first settlement window based on determining the first settlement window of the plurality of settlement windows to assign the transaction record; and
performing, by at least one processor, a settlement function for a transaction associated with the transaction record assigned to the first settlement window based on assigning the transaction record of the plurality of transaction records to the first settlement window.

2. The computer-implemented method of claim 1, further comprising receiving a message, wherein the message comprises the plurality of transaction records.

3. The computer-implemented method of claim 2, wherein the message is a clearing message or an authorization message.

4. The computer-implemented method of claim 1, wherein the settlement criteria of the first settlement window comprises data associated with settlement criteria of a jurisdiction.

5. The computer-implemented method of claim 1, wherein the settlement criteria of the first settlement window is based at least partially on at least one of the following:
transaction device type,
transaction device category,
product type,
product category,
transaction amount,
transaction category,
merchant type,
merchant category,
acquiring bank identification,
issuing bank identification,
country identification,
jurisdiction identification, or
any combination thereof.

6. The computer-implemented method of claim 1, further comprising determining data associated with a transaction type of each transaction associated with each transaction record and matching each transaction record with a type of transaction based on the data associated with the transaction type of each transaction.

7. The computer-implemented method of claim 6, wherein the type of transaction comprises at least one of:
an on-us transaction type,
a credit transaction type,
a debit transaction type, or
a merchant identification value transaction type.

8. The computer-implemented method of claim 1, further comprising routing a clearing message to the issuer and calculating:
a settlement obligation of the issuer associated with each transaction assigned to the first settlement window, and
an amount due to the acquirer net fees and charges.

9. The computer-implemented method of claim 1, further comprising performing risk protection on the first settlement window.

10. The computer-implemented method of claim 9, further comprising:
determining whether the transaction associated with the transaction record is associated with a risk parameter; and
wherein performing the settlement function for the transaction associated with the transaction record assigned to the first settlement window comprises:
blocking transmission of a settlement communication for the transaction record based on determining that the transaction record is a high-risk transaction record, or
transmitting a settlement communication for the transaction record based on determining that the transaction associated with the transaction record is not a high-risk transaction record.

11. The computer-implemented method of claim 1, further comprising receiving the settlement criteria of the first settlement window from an issuer that issued an account involved in a transaction of the plurality of transactions associated with the plurality of transactions.

12. The computer-implemented method of claim 1, wherein the first settlement window is associated with a time period for settlement that is independent of an end of day time period for settlement.

13. The computer-implemented method of claim 1, wherein each settlement window of the plurality of settlement windows is associated with a time period for settlement that is independent of an end of day time period for settlement.

14. The computer-implemented method of claim 1, wherein performing the settlement function for the transaction associated with the transaction record assigned to the first settlement window comprises:
facilitating a settlement communication for the transaction associated with the transaction record based on the first settlement window.

15. The computer-implemented method of claim 1, wherein performing the settlement function for the transaction associated with the transaction record assigned to the first settlement window comprises:
performing the settlement function for the transaction associated with the transaction record assigned to the first settlement window in real-time.

16. A system for dynamically designating a settlement window for a transaction within a settlement cycle between an acquirer and an issuer, comprising:
at least one processor configured or programmed to:
receive a plurality of transaction records associated with a plurality of transactions, wherein each transaction record comprises data associated with an account number of an account involved in a transaction associated with the transaction record, data associated with a transaction type of the transaction associated with the transaction record, and data associated with a transaction amount of the transaction associated with the transaction record;
determine a first settlement window of a plurality of settlement windows to assign a transaction record of the plurality of transaction records based on settlement criteria of the first settlement window and at least one of the following:
data associated with the account number of the account involved in the transaction associated with the transaction record,
data associated with the transaction type of the transaction associated with the transaction record,
data associated with the transaction amount of the transaction associated with the transaction record, or
any combination thereof;
assign the transaction record of the plurality of transaction records to the first settlement window based on determining the first settlement window of the plurality of settlement windows to assign the transaction record; and
perform a settlement function for a transaction associated with the transaction record assigned to the first settlement window based on assigning the transaction record of the plurality of transaction records to the first settlement window.

17. The system of claim 16, further comprising receiving a message, wherein the message comprises the plurality of transaction records.

18. The system of claim 17, wherein the message is a clearing message or an authorization message.

19. The system of claim 16, wherein the settlement criteria of the first settlement window comprises data associated with settlement criteria of a jurisdiction.

20. The system of claim 16, wherein the settlement criteria of the first settlement window is based at least partially on at least one of the following:
transaction device type,
transaction device category,
product type,
product category,
transaction amount,
transaction category,
merchant type,
merchant category,
acquiring bank identification,
issuing bank identification,
country identification,
jurisdiction identification, or
any combination thereof.

21.-30. (canceled)
